(19) United States
(12) Patent Application Publication
(10) Pub. No.: US 2024/0397576 A1
(43) Pub. Date: Nov. 28, 2024

(54) WIRELESS COMMUNICATION METHOD AND DEVICE

(71) Applicant: MEDIATEK Inc., Hsinchu City (TW)

(72) Inventors: Hao-Hua KANG, Hsinchu City (TW); Hui-Ping TSENG, Hsinchu City (TW); Cheng-Ying WU, Hsinchu City (TW); Chih-Chun KUO, Hsinchu City (TW); Shu-Min CHENG, Hsinchu City (TW); Chi-Han HUANG, Hsinchu City (TW); Yang-Hung PENG, Hsinchu City (TW); Jyh-Ding HU, Hsinchu City (TW); Chih-Pin CHU, Hsinchu City (TW); Chu-Ling CHANG, Hsinchu City (TW); Yen-Hsiung TSENG, Hsinchu City (TW); Chi-Fu KOH, Hsinchu City (TW); Yen CHUANG, Hsinchu City (TW)

(21) Appl. No.: 18/663,362

(22) Filed: May 14, 2024

Related U.S. Application Data
(60) Provisional application No. 63/503,735, filed on May 23, 2023.

(51) Int. Cl. H04W 76/27

(52) U.S. Cl. CPC H04W 76/27

(57) ABSTRACT

The application provides a wireless communication method and a wireless communication device. A part of payload is pre-fetched from a host to a data buffer under a store-and-forward mode before transmission begins. When data transmission begins, the part of the payload pre-fetched in the data buffer is transmitted to an antenna. A remaining part of the payload is fetched to the data buffer under a cut-through mode for payload transmission, wherein the remaining part of the payload is sent from the data buffer to the antenna for radiation.

### CROSS-REFERENCE TO RELATED ART

This application claims the benefit of U.S. provisional application Ser. No. 63/503,735, filed 2023 May 23, the disclosure of which is incorporated by reference herein in its entirety.

### TECHNICAL FIELD

The disclosure relates in general to a wireless communication method and device.

### BACKGROUND

A wireless communication device enables communication without the need for physical wires or cables. These wireless communication devices utilize various wireless technologies such as radio frequency (RF), infrared (IR), Bluetooth, Wi-Fi, or cellular networks to transmit and receive data, voice, or multimedia content over short or long distances. Common examples include smartphones, tablets, laptops, Bluetooth headsets, Wi-Fi routers, and GPS receivers. Wireless communication devices have revolutionized how we stay connected, allowing for seamless communication and access to information virtually anywhere and anytime.

In wireless communication devices, when data transmission is failed, it needs to re-transmit payload data, which is time consuming because of reloading payload data. In the realm of computing and networking, “payload” refers to the actual data being transmitted over a network or carried by a packet. It excludes any overhead data or control information necessary for the transmission process itself. For instance, in the context of internet protocols like TCP/IP, the payload refers to the part of the data packet that carries the actual user data, such as a web page, email message, or file being transferred. This payload is encapsulated within the packet along with header information containing details like source and destination addresses, error-checking codes, and other control information necessary for routing and delivery.

Further, components in wireless communication devices may require high processing speed, which increases cost of wireless communication devices.

Thus, there needs a wireless communication method and device which can lower the processing speed requirements of components and also avoid payload re-fetch when data re-transmission is needed.

### SUMMARY

According to one embodiment, a wireless communication method for a wireless communication device is provided. The wireless communication device comprises a host, an antenna and a data processing chip coupling to the host, the data processing chip having a component and a data buffer. The wireless communication method comprises: activating the component when the host informs to send payload to the component; after a first startup delay of the component, enabling the component in an active state during a predetermined period for pre-fetching a part of the payload from the host into the data buffer under a first mode; transiting the component from the active state into an inactive state; in response that a begin request is sent to the data buffer, activating the component when there is a remaining part of the payload in the host; beginning data transmission to transmit the part of the payload from the data buffer to the antenna under the first mode; and after a second startup delay of the component, enabling the component in the active state for fetching the remaining part of the payload, switching the data buffer to a second mode and sending the remaining part of the payload from the data buffer to the antenna under the second mode.

According to another embodiment, a wireless communication device is provided. The wireless communication device comprises: a host; a wireless chip coupled to the host; and an antenna coupled to the wireless chip. The wireless chip includes a component, a processor and a data buffer. The component is coupled to the host; the processor is coupled to the component and the data buffer; and the data buffer is coupled to the antenna. The processor is configured for: activating the component of the wireless communication device when the host informs to send payload to the component; after a first startup delay of the component, enabling the component in an active state during a predetermined period for pre-fetching a part of the payload from the host into the data buffer under a first mode; transiting the component from the active state into an inactive state; in response that the processor issues a begin request to the data buffer, activating the component when there is a remaining part of the payload in the host; beginning data transmission to transmit the part of the payload from the data buffer to the antenna under the first mode; and after a second startup delay of the component, enabling the component in the active state for fetching the remaining part of the payload, switching the data buffer to a second mode and sending the remaining part of the payload from the data buffer to the antenna under the second mode.

According to another embodiment, a wireless communication method for a wireless communication device method is provided. The wireless communication method includes: pre-fetching a part of payload from a host to a data buffer under a store-and-forward mode before transmission begins; when data transmission begins, transmitting the part of the payload pre-fetched in the data buffer to an antenna; and fetching a remaining part of the payload to the data buffer under a cut-through mode for payload transmission, the remaining part of the payload being sent from the data buffer to the antenna for radiation.

### BRIEF DESCRIPTION OF THE DRAWINGS

FIG. 1 shows a block diagram of a wireless communication device according to one embodiment of the application.

FIG. 2 shows a timing diagram in a wireless communication method according to one embodiment of the application.

FIG. 3 shows a timing diagram in a wireless communication method according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

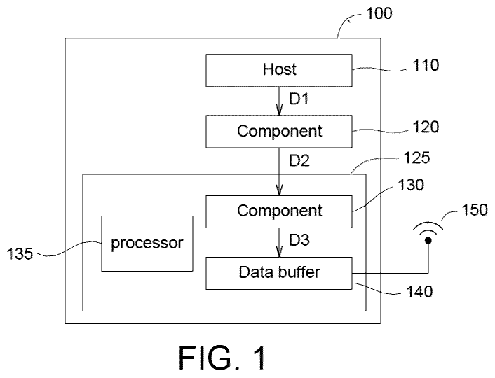

FIG. 1 shows a block diagram of a wireless communication device according to one embodiment of the application. The wireless communication device 100 includes a host 110, a first component 120, a wireless chip 125 and an antenna 150. The wireless chip 125 is for example but not limited by, a Wi-Fi chip. The wireless chip 125 (also referred as a data processing chip) includes a second component 130, a processor 135 and a data buffer 140. The first and the second components 120 and 130 are for example but not limited by, Peripheral Component Interconnect Express (PCIe) interface. The wireless communication device 100 is for example but not limited by, smartphones, tablets, laptops, Wi-Fi routers, and so on. The data buffer 140 is for example but not limited by, DRAM (dynamic random access memory).

The host 110 is for example but not limited by, Android platform or Windows platform of the wireless communication device 100. The host 110 sends data D1 to the first component 120. The data D1 is for example but not limited by, payload.

The first component 120 is coupled to the host 110 to receive data D1 from the first component 120. The first component 120 sends data D2 to the second component 130 based on data D1. In one possible example, data D2 and D1 may be the same or similar.

The wireless chip 125 is coupled to the first component 120. The wireless chip 125 receives data D2 from the first component 120 and sends to the antenna for transmission.

The second component 130 is coupled to the first component 120 to receive data D2 from the first component 120. The second component 130 sends data D3 to the data buffer 140 based on data D2. In one possible example, data D3, D2 and D1 may be the same or similar.

The data buffer 140 is coupled to the second component 130 to receive and to store data D3 from the second component 130. The data buffer 140 sends data D3 to the antenna 150 for data transmission.

The processor 135 is coupled to the data buffer 140 and the second component 130. The processor 135 controls the data buffer 140 and the second component 130 for performing the wireless communication method in one embodiment of the application. Operation details of the processor 135 are described below. The processor 135 could be, for example, implemented by a chip, a circuit block in the chip, a firmware circuit, a circuit board having several electronic elements and wires.

In Wi-Fi chip architecture, the data buffer 140 is designed to store the transmission (TX) payload fetched from host (or said from memory (DRAM) of the wireless communication device 100).

In one embodiment of the application, two data switching modes for TX data path are applied, i.e. cut-through mode and store-and-forward mode. The following table 1 compares the cut-through mode and store-and-forward mode.

In the cut-through mode, (1) the payload (i.e. data D3) is processed or transmitted before the payload is completely stored in data buffer 140; (2) the fetch operation for payload in the host 110 can be executed on-the-fly during the transmission (TX) time; (3) the latency is low (compared with the Store-and-forward mode); (4) the required buffer size is low (compared with the Store-and-forward mode); and (5) “Buffer under-run” may happen if the buffer has no enough payload for transmission. For the components 120/130 that process data before data is written to the data buffer 140 in the cut-through mode, the buffer under-run may occur if the components 120/130 need processing delay to begin data processing, or process data at a lower speed than the data that is being read for TX.

In the store-and-forward mode, (1) the payload (i.e. data D3) is processed or transmitted after the payload is completely stored in data buffer 140; (2) the payload shall be completely fetched into data buffer before begin of TX; (3) the latency is high (compared with the cut-through mode); (4) the required buffer size is high (compared with the cut-through mode); and “Buffer under-run” does not happen as the entire PPDU is already stored in the data buffer.

TABLE 1

| | Cut-through mode | Store-and-forward mode |
|---|---|---|
| Description | The payload is processed | The payload is processed |
| | and/or transmitted before | and/or transmitted after |
| | the payload is completely | the payload is completely |
| | stored in data buffer | stored in data buffer |
| PPDU fetch | The fetch operation for | The payload shall be |
| timing | payload in host can be | completely fetched into |
| | executed on-the-fly during | data buffer before the |
| | the TX time | begin of TX |
| Latency | Low | High |
| Buffer size | Low | High |
| Buffer | May happen if the buffer | Not happen as the entire |
| under-run | has no enough payload for | PPDU is already stored in |
| | transmission | the buffer |

PPDU: Packet Protocol Data Unit

In one embodiment of the application, a wireless communication method is disclosed. One embodiment of the application discloses an adaptive data fetch mode to overcome the data buffer under-run issue. The wireless communication method includes: (1) pre-fetching the partial payload (i.e. a part of the payload) to the data buffer 140 by store-and-forward mode before transmission begins; (2) when data transmission begins, transmitting the pre-fetched payload in the data buffer first to the antenna 150; and (3) fetching the remaining payload to the data buffer 140 by the cut-through mode for payload transmission for payload radiation.

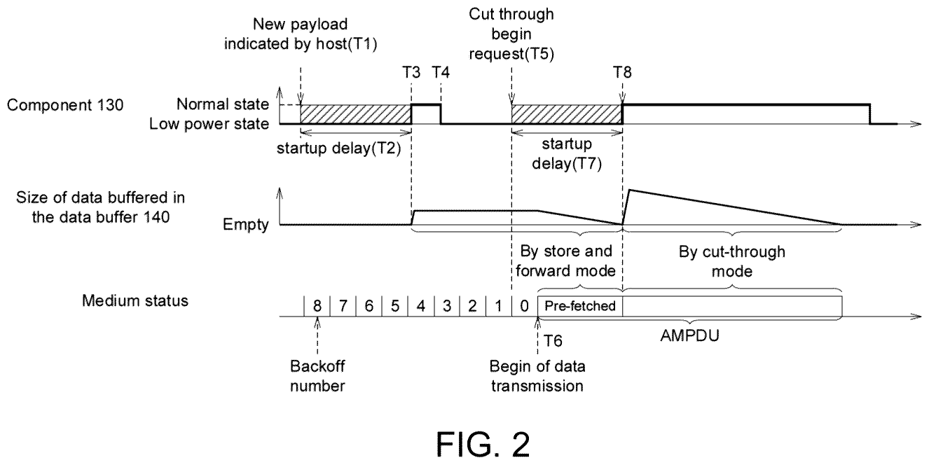

FIG. 2 shows a timing diagram in a wireless communication method according to one embodiment of the application.

At timing T1, the component 130 is activated (or awakened) when the host 110 informs to send new payload to the component 130.

During timing T2, the component 130 experiences startup delay.

At timing T3, after startup delay, the component 130 is transited from the low power state to the normal state. In other words, at timing T3, the component is enabled in an active state. At timing T4, the component is transited from the active state into an inactive state. Or said, at timing T4, the component is transited from the normal state to the low power state. During T3 to T4, the component 130 is activated in normal state during a predetermined period (i.e. During T3 to T4) and thus the partial payload is pre-fetched into the data buffer 140 under the store-and-forward mode. Thus, there is partial payload buffered in the data buffer 140.

At timing T5, the processor 135 issues a cut-through begin request to the data buffer 140 and the component 130 is activated (awakened).

At timing T6, data transmission for transmitting the payload from the data buffer 140 to the antenna 150 begins in response to “backoff” number counting to 0. In wireless communication, “backoff number” and “backoff counter” are terms commonly associated with the Carrier Sense Multiple Access with Collision Avoidance (CSMA/CA) protocol, which is often used in wireless networks like Wi-Fi. The backoff number is a random number generated by the wireless communication device during the contention period. This backoff number determines the time the device will wait before attempting to transmit data again after a collision or when the medium is sensed as busy. In summary, the backoff number is a randomly generated value used to calculate the waiting time before a retransmission attempt, while the backoff counter is the actual timer used by the device to count down this waiting period. These mechanisms play a crucial role in collision avoidance in wireless communication, thereby enhancing communication reliability and efficiency.

At timing T7, similar to timing T2, the component 130 experiences startup delay.

At timing T8, after startup delay, the component 130 is enabled in the active state for fetching the remaining part of the payload (or said, the component 130 is transited from the low power state to the normal state). After timing T8, the data buffer 140 is switched to the cut-through mode and data (for example but not limited by, AMPDU (aggregate MAC Protocol Data Unit)) is sent from the data buffer 140 to the antenna 150 under cut-through mode.

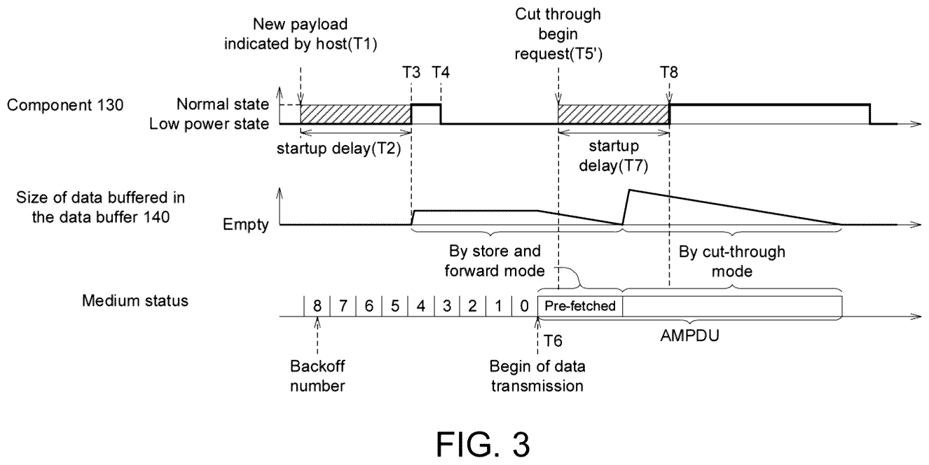

FIG. 3 shows a timing diagram in a wireless communication method according to one embodiment of the application. FIG. 3 is similar to FIG. 2. Difference between FIG. 2 and FIG. 3 is as follows.

In FIG. 2, the timing T5 (during which the processor 135 issues a cut-through begin request to the data buffer 140 and the component 130 is activated) is before the timing T6 (data transmission begins). In FIG. 3, the timing T5′ (during which the processor 135 issues a cut-through begin request to the data buffer 140 and the component 130 is activated) is after the timing T6 (data transmission begins).

In one embodiment of the application, an adaptive data fetch mode is disclosed to overcome the data buffer under-run issue. Original behaviors of the component (120 and/or 130) can be kept (that is, the existing component can be applied in one embodiment of the application).

In one embodiment of the application, less data buffer size is required compared to pure store-and-forward mode. Because partial payload is pre-fetched in the data buffer (during timing T3 to T4 in FIG. 2), the data buffer does not need high size.

In one embodiment of the application, the transmission latency is reduced compared to pure store-and-forward mode because the partial payload buffered in the data buffer can be transmitted after the expected begin time of data transmission (the timing T6 in FIG. 2).

In one embodiment of the application, payload re-fetch is prevented when data re-transmission is needed. The payload in the data buffer 140 is flushed only when transmission of the payload successes. Thus, if transmission of the payload in the data buffer is not successful, the payload is stilled buffered in the data buffer and thus there is no need to re-fetch the payload whose transmission is failed.

In one embodiment of the application, the processing speed requirements of the components (120 and/or 130) can be reduced when more payload is pre-fetched before transmission.

The foregoing mainly describes the solutions provided in the embodiments of the application from a perspective of interaction in wireless communication. It may be understood that, to implement the foregoing functions, the wireless communication device includes corresponding hardware structures and/or software modules for performing the functions described in wireless communication according to embodiments of the application. A person skilled in the art should easily be aware that, in combination with units and algorithm steps of the examples described in the embodiments disclosed in this specification, this application may be implemented in a hardware form or in a form of combining hardware with computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In one embodiment of the application, the wireless communication device may be divided into function modules based on the foregoing method examples. For example, each function module may be obtained through division based on each corresponding function, or two or more functions may be integrated into one processing module. The integrated module may be implemented in a form of hardware, or may be implemented in a form of a software function module. It should be noted that, in the embodiments of this application, division into modules is an example, and is merely logical function division. During actual implementation, another division manner may be used. An example in which each function module is obtained through division based on each corresponding function is used below for description.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A wireless communication method for a wireless communication device, the wireless communication device comprising a host, an antenna and a data processing chip coupling to the host, the data processing chip having a component and a data buffer, the wireless communication method comprising:
activating the component when the host informs to send payload to the component;
after a first startup delay of the component, enabling the component in an active state during a predetermined period for pre-fetching a part of the payload from the host into the data buffer under a first mode;
transiting the component from the active state into an inactive state;
in response that a begin request is sent to the data buffer, activating the component when there is a remaining part of the payload in the host;
beginning data transmission to transmit the part of the payload from the data buffer to the antenna under the first mode; and
after a second startup delay of the component, enabling the component in the active state for fetching the remaining part of the payload, switching the data buffer to a second mode and sending the remaining part of the payload from the data buffer to the antenna under the second mode.

2. The wireless communication method according to claim 1, wherein the first mode is a store-and-forward mode and the second mode is a cut-through mode.

3. A wireless communication device, comprising:
a host;
a wireless chip coupled to the host; and
an antenna coupled to the wireless chip,
the wireless chip includes a component, a processor and a data buffer,
the component is coupled to the host,
the processor is coupled to the component and the data buffer,
the data buffer is coupled to the antenna,
wherein the processor is configured for:
activating the component of the wireless communication device when the host informs to send payload to the component;
after a first startup delay of the component, enabling the component in an active state during a predetermined period for pre-fetching a part of the payload from the host into the data buffer under a first mode;
transiting the component from the active state into an inactive state;
in response that the processor issues a begin request to the data buffer, activating the component when there is a remaining part of the payload in the host;
beginning data transmission to transmit the part of the payload from the data buffer to the antenna under the first mode; and
after a second startup delay of the component, enabling the component in the active state for fetching the remaining part of the payload, switching the data buffer to a second mode and sending the remaining part of the payload from the data buffer to the antenna under the second mode.

4. The wireless communication device according to claim 3, wherein the first mode is a store-and-forward mode and the second mode is a cut-through mode.

5. A wireless communication method for a wireless communication device, the wireless communication method including:
pre-fetching a part of payload from a host to a data buffer under a store-and-forward mode before transmission begins;
when data transmission begins, transmitting the part of the payload pre-fetched in the data buffer to an antenna; and
fetching a remaining part of the payload to the data buffer under a cut-through mode for payload transmission, the remaining part of the payload being sent from the data buffer to the antenna for radiation.
